(19) United States
(12) Patent Application Publication
(10) Pub. No.: US 2014/0153086 A1
(43) Pub. Date: Jun. 5, 2014

(54) POLYIMIDE OPTICAL ARTICLES HAVING SELECTIVE TRANSMITTANCE PROPERTIES

(71) Applicant: SABIC INNOVATIVE PLASTICS IP B.V., BERGEN OP ZOOM (NL)

(72) Inventors: Feng Cao, Loudonville, NY (US); Aditya Narayanan, Evansville, IN (US)

(73) Assignee: SABIC INNOVATIVE PLASTICS IP B.V., BERGEN OP ZOOM (NL)

(21) Appl. No.: 14/091,527

(22) Filed: Nov. 27, 2013

Related U.S. Application Data
(60) Provisional application No. 61/732,304, filed on Dec. 1, 2012.

(51) Int. Cl. G02B 13/14

(52) U.S. Cl. CPC G02B 13/14
USPC 359/356

(57) ABSTRACT

An article comprises a lens having a width of 0.1 millimeters to 100 millimeters, a length of 0.5 millimeters to 500 millimeters, and a thickness of 0.2 millimeters to 5 millimeters; which transmits more than 60% of light having a wavelength of 760 nanometers to 2500 nanometers. The lens comprises a polymer and a colorant component. The lens is transparent and dimensionally stable at a wall thickness of 0.2 millimeters to 5.0 millimeters and remains transparent and dimensionally stable after being (a) exposed to a precondition of 60° C./60% relative humidity for 120 hours and (b) then subjected to a lead free solder test having a peak temperature of 260° C. for up to 30 seconds.

### CROSS-REFERENCE TO RELATED APPLICATIONS

This application claims the benefit of U.S. Provisional Application No. 61/732,304, filed Dec. 1, 2012, which is incorporated by reference in its entirety herein.

### BACKGROUND

Optical articles comprising a polyimide are disclosed herein.

Fiber optic technology has been traditionally used for long distance communication but with increases in internet usage for large amounts of data transfer, much of the bandwidth in the existing optical network is used for this data communication and at higher rates. Increasingly fiber optics is being used to connect computer networks to meet the huge demand of data and at higher data transfer speeds, even at shorter distances.

As part of evolving fiber optic technology, there is a need for optical materials and lenses with light transmission in the near IR range (760 nanometers (nm) to 2500 nm) and these materials and lens must also block visible light (380 to 670 or even 700 nm) to reduce and/or eliminate visible light interference. The lenses are required to retain their shape at temperatures in excess of 240° C., since laser transmitter/transceiver modules are exposed to high temperatures during their placement on printed circuit boards by a solder reflow process or a solder bath, especially lead free solder processes. For this reason, only polymers with high glass transition temperatures can be used. These materials and lenses must be able to retain the optical characteristics and be dimensionally stable after exposure to humidity.

Hence there exists an unmet need for optical materials and articles comprising a polymer with high transmission in the range of 760 nm to 2500 nm and little or no transmission in the range of 380 to 670 or even 700 nm, dimensional stability even after exposure to humidity and capable of withstanding lead free solder processes.

### BRIEF SUMMARY

Disclosed herein is an article comprising a lens having a width of 0.1 millimeters to 100 millimeters, a length of 0.5 millimeters to 500 millimeters, and a thickness of 0.2 millimeters to 5 millimeters; and the lens transmits more than 60% of light having a wavelength of 760 nanometers to 2500 nanometers wherein the lens comprises a polymer and a colorant component. The polymer is a high heat polymer having a glass transition temperature that is more than 180° C. and the high heat polymer is selected from the group consisting of polyimides, polyphenylene sulfones, polyethersulfones, polysulfones, and polyetheretherketones, and combinations thereof. In some embodiments the polymer comprises a polyimide comprising structural units derived from

(A) a dianhydride/diamine pair wherein the pair comprises:
(i) oxydiphthalic anhydride and diaminodiphenylsulfone, or
(ii) a dianhydride selected from the group consisting of oxydiphthalic anhydride, 3,3, bisphenol A dianhydride, 4,4, bisphenol A dianhydride, and combinations of the foregoing dianhydrides and a diamine selected from the group consisting of meta-phenylenediamine, para-phenylenediamine, diaminodiphenyl sulfone, oxydianiline, and combinations of the foregoing diamines,

(B) a chloro-substituted phthalic anhydride, a diamine selected from the group of meta-phenylenediamine, para-phenylenediamine, diaminodiphenyl sulfone, oxydianiline and combinations thereof, and a dihydroxy phenol salt; or

(C) a combination of (A) and (B).

The colorant component comprises (a) at least two organic dyes, (b) at least an organic dye and an organic pigment, (c) at least two organic pigments, or (d) combinations thereof. The lens is transparent and dimensionally stable at a wall thickness of 0.2 millimeters to 5.0 millimeters and remains transparent and dimensionally stable after being (a) exposed to a precondition of 60° C./60% relative humidity for 120 hours and (b) then subjected to a lead free solder test having a peak temperature of 260° C. for up to 30 seconds. In some embodiments the lens transmits more than 50% of light having a wavelength of 760 nanometers to 2500 nanometers.

### BRIEF DESCRIPTION OF THE FIGURES

FIGS. 1-4 are graphical representations of data from the Examples.

### DETAILED DESCRIPTION

Our invention is based, in part, on the observation that it is now possible to design a lens that has high temperature resistance and that can selectively transmit light at different regions. By using a specific combination of colorants and polymers, it is now possible to make lenses that are transparent and dimensionally stable at a wall thickness of at least 0.2 millimeters to 5.0 millimeters and remain transparent and dimensionally stable after being (a) exposed to a precondition of 60° C./60% relative humidity for 120 hours and (b) then subjected to a lead free solder test having a peak temperature of 260° C. for up to 30 seconds.

Disclosed herein is an article comprising a lens. The lens has a width of 0.1 millimeters to 100 millimeters, a length of 0.5 millimeters to 500 millimeters, and a thickness of 0.2 millimeters to 5 millimeters; and transmits more than 60% of light having a wavelength of 760 nanometers to 2500 nanometers. Within this range the lens can specifically transmit more than 60% of light having a wavelength of 1310 nanometers. Also within this range the lens can specifically transmit more than 60% of light having a wavelength of 1550 nanometers. Also within this range the lens can specifically transmit more than 60% of light having a wavelength of 850 nanometers. The lens can have light transmission less than 15% at a wavelength of 380 to 700 nm. The lens can transmit more than 15% of light having a wavelength of greater than 700 to 760 nm.

In some embodiments the lens has a width of 0.1 millimeters to 100 millimeters, a length of 0.5 millimeters to 500 millimeters, and a thickness of 0.2 millimeters to 5 millimeters; and transmits more than 50% of light having a wavelength of 760 nanometers to 2500 nanometers. Within this range the lens can specifically transmit more than 50% of light having a wavelength of 1310 nanometers. Also within this range the lens can specifically transmit more than 50% of light having a wavelength of 1550 nanometers. Also within this range the lens can specifically transmit more than 50% of light having a wavelength of 850 nanometers. The lens can have light transmission less than 20% at a wavelength of 380 to 700 nm. The lens can transmit more than 0% of light having a wavelength of greater than 670 to 760 nm.

Other than in the operating examples or where otherwise indicated, all numbers or expressions referring to quantities of ingredients, reaction conditions, and the like, used in the specification and claims are to be understood as modified in all instances by the term “about.” Various numerical ranges are disclosed in this patent application. Because these ranges are continuous, they include every value between the minimum and maximum values. Unless expressly indicated otherwise, the various numerical ranges specified in this application are approximations.

The terms “first,” “second,” and the like, “primary,” “secondary,” and the like, as used herein do not denote any order, quantity, or importance, but rather are used to distinguish one element from another. The terms “a” and “an” do not denote a limitation of quantity, but rather denote the presence of at least one of the referenced item. “Optional” or “optionally” means that the subsequently described event or circumstance may or may not occur, and that the description includes instances where the event occurs and instances where it does not. The endpoints of all ranges directed to the same component or property are inclusive of the endpoint and independently combinable. Reference throughout the specification to “one embodiment,” “another embodiment,” “an embodiment,” “some embodiments,” and so forth, means that a particular element (e.g., feature, structure, property, and/or characteristic) described in connection with the embodiment is included in at least one embodiment described herein, and may or may not be present in other embodiments. In addition, it is to be understood that the described element(s) may be combined in any suitable manner in the various embodiments.

Compounds are described using standard nomenclature. For example, any position not substituted by any indicated group is understood to have its valency filled by a bond as indicated, or a hydrogen atom. A dash (“-”) that is not between two letters or symbols is used to indicate a point of attachment for a substituent. For example, —CHO is attached through carbon of the carbonyl group.

The term “alkyl” is intended to include both C₁₋₃₀ branched and straight-chain, unsaturated aliphatic hydrocarbon groups having the specified number of carbon atoms. Examples of alkyl include, but are not limited to, methyl, ethyl, n-propyl, i-propyl, n-butyl, s-butyl, t-butyl, n-pentyl, s-pentyl, n- and s-hexyl, n- and s-heptyl, and, n- and s-octyl. The term “aryl” is intended to mean an aromatic moiety containing the specified number of carbon atoms, such as, but not limited to phenyl, tropone, indanyl or naphthyl.

The term “transparency” means an article of the invention has a transmission of at least 30% at a thickness ranging from 0.2 to 3.2 mm at a wavelength ranging from 760 to 2500 nm, where “thickness” refers to the thickness of an article such as a lens.

Light transmission, when associated with a specific percentage, can be determined at 2.5 millimeters unless otherwise stated.

The term “dimensionally stable” means that an article of this invention exhibits a surface appearance that does not exhibit any cracks (popcorning effect), as defined by J-STD-020-C (2004).

The lens is transparent and dimensionally stable at a wall thickness of 0.2 millimeters to 5 millimeters and remains transparent and dimensionally stable after being (a) exposed to a precondition of 60° C./60% relative humidity for 120 hours and (b) then subjected to a lead free solder test having a peak temperature of 260° C. for up to 30 seconds. The lens comprises a polymer which comprises a polyimide as described below and a colorant component. The lens can consist of a polyimide or combination polyimides as described below.

The lens can be transparent and dimensionally stable at a wall thickness of 0.2 millimeters to 5.0 millimeters after being (a) exposed to a precondition of 85° C./85% relative humidity for 120 hours and (b) subjected to a lead free solder test for 30 seconds at 260° C.

The lens can have a transparency that is greater than or equal to 40% at a thickness of 2 millimeters.

The lens can have a transparency that is greater than or equal to 50% at a thickness of 2 millimeters.

The lens can transmit light selectively in various wavelength ranges. In one embodiment, the lens transmits less than 20% of light having a wavelength selected from the group consisting of 380 to 670 nm, 380 to 671 nm, 380 to 672 nm, 380 to 673 nm, 380 to 674 nm, 380 to 675 nm, 380 to 676 nm, 380 to 677 nm, 380 to 678 nm, 380 to 679 nm, 380 to 680 nm, 380 to 681 nm, 380 to 682 nm, 380 to 683 nm, 684 nm, 380 to 685 nm, 380 to 686 nm, 380 to 687 nm, 380 to 688 nm, 380 to 689 nm, 380 to 690 nm, 380 to 691 nm, 380 to 692 nm, 380 to 693 nm, 380 to 694 nm, 380 to 695 nm, 380 to 696 nm, 380 to 697 nm, 380 to 698 nm, 380 to 700 nm, and combinations thereof. In another embodiment, the lens transmits more than 5% of light having a wavelength selected from the group consisting of from more than 670 to 760 nm, 671 to 760 nm, 672 to 760 nm, 673 to 760 nm, 673 to 760 nm, 673 to 760 nm, 674 to 760 nm, 675 to 760 nm, 676 to 760 nm, 677 to 760 nm, 678 to 760 nm, 679 to 760 nm, 680 to 760 nm, 681 to 760 nm, 682 to 760 nm, 683 to 760 nm, 684 to 760 nm, 685 to 760 nm, 686 to 760 nm, 687 to 760 nm, 688 to 760 nm, 689 to 760 nm, 690 to 760 nm, 691 to 760 nm, 692 to 760 nm, 693 to 760 nm, 694 to 760 nm, 695 to 760 nm, 696 to 760 nm, 697 to 760 nm, 698 to 760 nm, 699 to 760 nm, 700 to 760 nm, and combinations thereof.

In some embodiments, the lens transmits more than zero percent of light having a wavelength selected from the group consisting of from more than 670 to 760 nm, 671 to 760 nm, 672 to 760 nm, 673 to 760 nm, 673 to 760 nm, 673 to 760 nm, 674 to 760 nm, 675 to 760 nm, 676 to 760 nm, 677 to 760 nm, 678 to 760 nm, 679 to 760 nm, 680 to 760 nm, 681 to 760 nm, 682 to 760 nm, 683 to 760 nm, 684 to 760 nm, 685 to 760 nm, 686 to 760 nm, 687 to 760 nm, 688 to 760 nm, 689 to 760 nm, 690 to 760 nm, 691 to 760 nm, 692 to 760 nm, 693 to 760 nm, 694 to 760 nm, 695 to 760 nm, 696 to 760 nm, 697 to 760 nm, 698 to 760 nm, 699 to 760 nm, 700 to 760 nm, and combinations thereof.

In another embodiment, the lens selectively transmits light from a member selected from the group consisting of: (1) less than 20% of light having a wavelength of 380 to 670 nm and more than 5% of light having a wavelength of from more than 670 to 760 nm, (2) less than 20% of light having a wavelength of 380 to 671 nm, and more than 5% of light having a wavelength of from more than 671 to 760 nm, (3) less than 20% of light having a wavelength of 380 to 672 nm and more than 5% of light having a wavelength of from more than 672 to 760 nm, (4) less than 20% of light having a wavelength of 380 to 673 nm, and more than 5% of light having a wavelength of from more than 673 to 760 nm, (5) less than 20% of light having a wavelength of 380 to 674 nm, and more than 5% of light having a wavelength of from more than 674 to 760 nm (6) less than 20% of light having a wavelength of 380 to 675 nm, and more than 5% of light having a wavelength of from more than 675 to 760 nm, (7) less than 20% of light having a wavelength of 380 to 676 nm, and more than 5% of light having a wavelength of from more than 676 to 760 nm, (8), less than 20% of light having a wavelength of 380 to 677 nm, and more than 5% of light having a wavelength of from more than 677 to 760 nm, (9) less than 20% of light having a wavelength of 380 to 678 nm, and more than 5% of light having a wavelength of from more than 678 to 760 nm, (10) less than 20% of light having a wavelength of 380 to 679 nm, and more than 5% of light having a wavelength of from more than 679 to 760 nm, (11) less than 20% of light having a wavelength of 380 to 680 nm, and more than 5% of light having a wavelength of from more than 680 to 760 nm, (12) less than 20% of light having a wavelength of 380 to 681 nm, and more than 5% of light having a wavelength of from more than 681 to 760 nm, (13) less than 20% of light having a wavelength of 380 to 682 nm, and more than 5% of light having a wavelength of from more than 682 to 760 nm, (14) less than 20% of light having a wavelength of 380 to 683 nm, and more than 5% of light having a wavelength of from more than 683 to 760 nm, (15) less than 20% of light having a wavelength of 684 nm and more than 5% of light having a wavelength of from more than 684 to 760 nm, (16) less than 20% of light having a wavelength of 380 to 685 nm, and more than 5% of light having a wavelength of from more than 685 to 760 nm, (17) less than 20% of light having a wavelength of 380 to 686 nm, and more than 5% of light having a wavelength of from more than 686 to 760 nm, (18) less than 20% of light having a wavelength of 380 to 687 nm, and more than 5% of light having a wavelength of from more than 687 to 760 nm, (19) less than 20% of light having a wavelength of 380 to 688 nm, and more than 5% of light having a wavelength of from more than 688 to 760 nm, (20) less than 20% of light having a wavelength of 380 to 689 nm, and more than 5% of light having a wavelength of from more than 689 to 760 nm, (21) less than 20% of light having a wavelength of 380 to 690 nm, and more than 5% of light having a wavelength of from more than 690 to 760 nm, (22) less than 20% of light having a wavelength of 380 to 691 nm, and more than 5% of light having a wavelength of from more than 691 to 760 nm, (23) less than 20% of light having a wavelength of 380 to 692 nm, and more than 5% of light having a wavelength of from 692 to 760 nm, (24) less than 20% of light having a wavelength of 380 to 693 nm, and more than 5% of light having a wavelength of from 693 to 760 nm, (25) less than 20% of light having a wavelength of 380 to 694 nm, and more than 5% of light having a wavelength of from 694 to 760 nm, (26) less than 20% of light having a wavelength of 380 to 695 nm, and more than 5% of light having a wavelength of from 695 to 760 nm, (27) less than 20% of light having a wavelength of 380 to 696 nm, and more than 5% of light having a wavelength of from 696 to 760 nm, (28) less than 20% of light having a wavelength of 380 to 697 nm, and more than 5% of light having a wavelength of from 697 to 760 nm, (29) less than 20% of light having a wavelength of 380 to 698 nm, and more than 5% of light having a wavelength of from 698 to 760 nm, (30) less than 20% of light having a wavelength of 380 to 699 nm, and more than 5% of light having a wavelength of from 699 to 760 nm, (31) less than 20% of light having a wavelength of 380 to 700 nm, and more than 5% of light having a wavelength of from 700 to 760 nm, and combinations thereof.

In another embodiment, the lens selectively transmits light from a member selected from the group consisting of: (1) less than 20% of light having a wavelength of 380 to 670 nm and more than zero percent of light having a wavelength of from more than 670 to 760 nm, (2) less than 20% of light having a wavelength of 380 to 671 nm, and more than zero percent of light having a wavelength of from more than 671 to 760 nm, (3) less than 20% of light having a wavelength of 380 to 672 nm and more than zero percent of light having a wavelength of from more than 672 to 760 nm, (4) less than 20% of light having a wavelength of 380 to 673 nm, and more than zero percent of light having a wavelength of from more than 673 to 760 nm, (5) less than 20% of light having a wavelength of 380 to 674 nm, and more than zero percent of light having a wavelength of from more than 674 to 760 nm (6) less than 20% of light having a wavelength of 380 to 675 nm, and more than zero percent of light having a wavelength of from more than 675 to 760 nm, (7) less than 20% of light having a wavelength of 380 to 676 nm, and more than zero percent of light having a wavelength of from more than 676 to 760 nm, (8), less than 20% of light having a wavelength of 380 to 677 nm, and more than zero percent of light having a wavelength of from more than 677 to 760 nm, (9) less than 20% of light having a wavelength of 380 to 678 nm, and more than zero percent of light having a wavelength of from more than 678 to 760 nm, (10) less than 20% of light having a wavelength of 380 to 679 nm, and more than zero percent of light having a wavelength of from more than 679 to 760 nm, (11) less than 20% of light having a wavelength of 380 to 680 nm, and more than zero percent of light having a wavelength of from more than 680 to 760 nm, (12) less than 20% of light having a wavelength of 380 to 681 nm, and more than zero percent of light having a wavelength of from more than 681 to 760 nm, (13) less than 20% of light having a wavelength of 380 to 682 nm, and more than zero percent of light having a wavelength of from more than 682 to 760 nm, (14) less than 20% of light having a wavelength of 380 to 683 nm, and more than zero percent of light having a wavelength of from more than 683 to 760 nm, (15) less than 20% of light having a wavelength of 684 nm and more than zero percent of light having a wavelength of from more than 684 to 760 nm, (16) less than 20% of light having a wavelength of 380 to 685 nm, and more than zero percent of light having a wavelength of from more than 685 to 760 nm, (17) less than 20% of light having a wavelength of 380 to 686 nm, and more than zero percent of light having a wavelength of from more than 686 to 760 nm, (18) less than 20% of light having a wavelength of 380 to 687 nm, and more than zero percent of light having a wavelength of from more than 687 to 760 nm, (19) less than 20% of light having a wavelength of 380 to 688 nm, and more than zero percent of light having a wavelength of from more than 688 to 760 nm, (20) less than 20% of light having a wavelength of 380 to 689 nm, and more than zero percent of light having a wavelength of from more than 689 to 760 nm, (21) less than 20% of light having a wavelength of 380 to 690 nm, and more than zero percent of light having a wavelength of from more than 690 to 760 nm, (22) less than 20% of light having a wavelength of 380 to 691 nm, and more than zero percent of light having a wavelength of from more than 691 to 760 nm, (23) less than 20% of light having a wavelength of 380 to 692 nm, and more than zero percent of light having a wavelength of from 692 to 760 nm, (24) less than 20% of light having a wavelength of 380 to 693 nm, and more than zero percent of light having a wavelength of from 693 to 760 nm, (25) less than 20% of light having a wavelength of 380 to 694 nm, and more than zero percent of light having a wavelength of from 694 to 760 nm, (26) less than 20% of light having a wavelength of 380 to 695 nm, and more than zero percent of light having a wavelength of from 695 to 760 nm, (27) less than 20% of light having a wavelength of 380 to 696 nm, and more than zero percent of light having a wavelength of from 696 to 760 nm, (28) less than 20% of light having a wavelength of 380 to 697 nm, and more than zero percent of light having a wavelength of from 697 to 760 nm, (29) less than 20% of light having a wavelength of 380 to 698 nm, and more than zero percent of light having a wavelength of from 698 to 760 nm, (30) less than 20% of light having a wavelength of 380 to 699 nm, and more than zero percent of light having a wavelength of from 699 to 760 nm, (31) less than 20% of light having a wavelength of 380 to 700 nm, and more than zero percent of light having a wavelength of from 700 to 760 nm, and combinations thereof.

The polyimide can comprise structural units derived from (A) a dianhydride/diamine pair comprising (i) oxydiphthalic anhydride and diaminodiphenylsulfone or (ii) a dianhydride selected from the group consisting of oxydiphthalic anhydride, 3,3, bisphenol A dianhydride, 4,4, bisphenol A dianhydride, and combinations of the foregoing dianhydrides and a diamine selected from the group consisting of meta-phenylenediamine, para-phenylenediamine, diaminodiphenyl sulfone, oxydianiline, and combinations of the foregoing diamines; (B) a chloro-substituted phthalic anhydride, a diamine selected from the group of meta-phenylenediamine, para-phenylenediamine, diaminodiphenyl sulfone, oxydianiline and combinations thereof, and a dihydroxy phenol salt; or (C) a combination of (A) and (B).

The polyimide can consist of structural units derived from (A) a dianhydride/diamine pair comprising (i) oxydiphthalic anhydride and diaminodiphenylsulfone or (ii) a dianhydride selected from the group consisting of oxydiphthalic anhydride, 3,3, bisphenol A dianhydride, 4,4, bisphenol A dianhydride, and combinations of the foregoing dianhydrides and a diamine selected from the group consisting of meta-phenylenediamine, para-phenylenediamine, diaminodiphenyl sulfone, oxydianiline, and combinations of the foregoing diamines; (B) a chloro-substituted phthalic anhydride, a diamine selected from the group of meta-phenylenediamine, para-phenylenediamine, diaminodiphenyl sulfone, oxydianiline and combinations thereof, and a dihydroxy phenol salt; or (C) a combination of (A) and (B).

Structural units derived from oxydiphthalic anhydride and diaminodiphenylsulfone have the formula

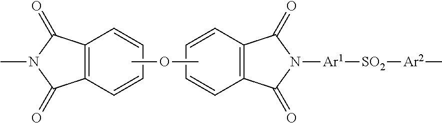

wherein Ar¹ and Ar² are phenyl groups.

Structural units derived from a dianhydride selected from the group consisting of oxydiphthalic anhydride, 3,3, bisphenol A dianhydride, 4,4, bisphenol A dianhydride, and a diamine selected from the group consisting of meta-phenylenediamine, para-phenylenediamine, diaminodiphenyl sulfone, oxydianiline have the formula

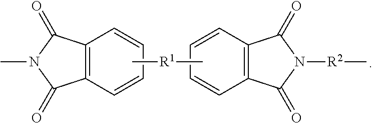

R¹ can be an oxy group or can have one of the following structures

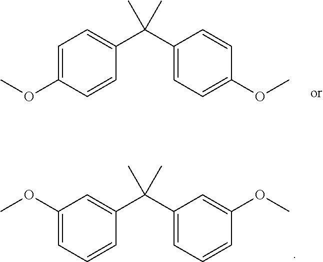

R² can have one of the following structures

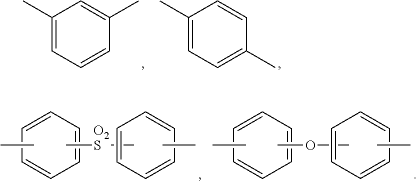

Structural units derived from a chloro-substituted phthalic anhydride, a diamine selected from the group of meta-phenylenediamine, para-phenylenediamine, diaminodiphenyl sulfone, oxydianiline and combinations thereof, and a dihydroxy phenol salt have the formula

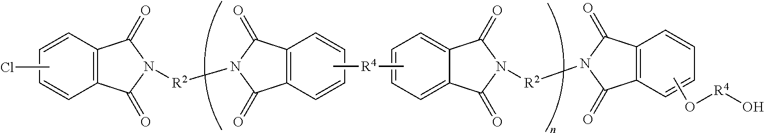

wherein R² is defined as above and R⁴ is derived from a dihydroxy phenol. Suitable dihydroxy phenols include those having the formula

OH-A²-OH

wherein A² is a divalent aromatic hydrocarbon radical, such as

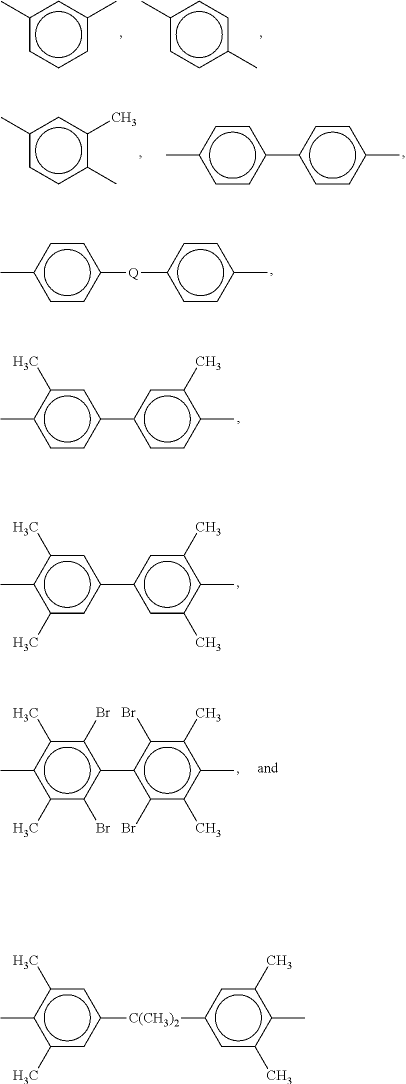

wherein Q includes but is not limited to a divalent moiety including —O—, —S—, —C(O)—, —SO₂—, —SO—, —C_{y}H_{2y}— (y being an integer from 1 to 5), and halogenated derivatives thereof, including perfluoroalkylene groups.

The lens can comprise two polyimide polymers that form a non-delaminated blend. The term “non-delaminated” refers to the property of a composition or an article derived from the composition, in which the article or the composition does not exhibit visually observed separation of a surface layer showing a flaking or onion skin effect. A non-delaminated article may also be referred to herein as “essentially free from delamination.” The blend of two polyimide polymers can be miscible.

The first polyimide can be present in an amount of 50 to 99 weight percent; the second polyimide can be present in an amount of 1 to 50 weight percent; and the thermoplastic composition can further comprise 0 to 70 weight percent of a component selected from the group consisting of fillers, reinforcements, additives, and combinations thereof; wherein the first polyimide, the second polyimide, and the component are present at a total weight percent of 100, as long as a lens made from the composition is transparent and dimensionally stable at a wall thickness of at least 0.2 millimeters to 5.0 millimeters and remains transparent and dimensionally stable after being (a) exposed to a precondition of 60° C./60% relative humidity for 120 hours and (b) then subjected to a lead free solder test having a peak temperature of 260° C. for up to 30 seconds.

When the lens comprises two polyimides the first polyimide polymer can comprise structural units derived from oxydiphthalic anhydride and diaminodiphenyl sulfone; and the second polyimide polymer can comprise structural units derived from a dianhydride/diamine pair selected from the group consisting of (i) 3,3 bisphenol dianhydride and diaminodiphenyl sulfone, (ii) 4,4, bisphenol A dianhydride and metaphenylene diamine, (iii) 4,4, bisphenol A dianhydride and para-phenylenediamine, (iv) 4,4 bisphenol dianhydride and diaminodiphenyl sulfone, and (v) combinations of the dianhydride/diamine pairs (ii)-(iv).

Alternatively, the lens comprises two polyimides the first polyimide polymer can comprise structural units derived from 3,3 bisphenol dianhydride and diaminodiphenyl sulfone; and the second polyimide polymer can comprise structural units derived from a dianhydride/diamine pair selected from the group consisting of (i) 4,4, bisphenol A dianhydride and metaphenylene diamine, (ii) 4,4, bisphenol A dianhydride and para-phenylenediamine, (iii) 4,4 bisphenol dianhydride and diaminodiphenyl sulfone, and (iv) combinations of the dianhydride/diamine pairs (i)-(iii).

It is also contemplated that the lens can further comprise a polymer other than a polyimide. The non-polyimide polymer can be selected from the group consisting of polyesters, polyestercarbonates, polysulfones, polyether sulfones, polybenzimidizole, polyketones, and combinations of the foregoing polymers, as long as a lens made from the blend of polymers is transparent and dimensionally stable at a wall thickness of at least 0.2 millimeters to 5.0 millimeters and remains transparent and dimensionally stable after being (a) exposed to a precondition of 60° C./60% relative humidity for 120 hours and (b) then subjected to a lead free solder test having a peak temperature of 260° C. for up to 30 seconds.

In one embodiment, the composition comprises a polyketone and the polyketone is present in an amount less than 20 weight percent, based on the weight of the composition.

The polymer or polymer blend can have a coefficient of thermal expansion of less than or equal to 100 ppm/° C. from 30° C. to 200° C. as measured by thermal mechanical analysis with a thermal ramp rate of 5° C./minute. (as per ASTM E 831-06)

The polymer or polymer blend can have a continuous use temperature greater than or equal to 150° C.

The colorant component is selected from the group of (a) at least two organic dyes, (b) at least an organic dye and an organic pigment, (c) at least two organic pigments, and (d) combinations thereof.

In one embodiment the colorant comprises at least two organic dyes. The at least two organic dyes are selected to provide a desired black color. Suitable dye classes from which the at least two organic dyes can be selected include anthraquinones, anthrapyridones, perylenes, anthracenes, perinones, indanthrones, quinacridones, xanthenes, thioxanthenes, oxazines, oxazolines, indigoids, thioindigoids, quinophthalones, naphthalimides, cyanines, methines, pyrazolones, lactones, coumarins, bis-benzoxazolylthiophenes, naphthalenetetracarboxylic acids, phthalocyanines, triarylmethanes, aminoketones, bis(styryl)biphenyls, azines, rhodamines, derivatives of the foregoing, and mixtures thereof. The at least two organic dyes can be selected from the group consisting of (i) a mixture comprising a green organic dye and a red organic dye, (ii) a mixture comprising an orange organic dye, blue organic dye, and red organic dye (iii) a mixture comprising a purple organic dye, a yellow organic dye and a blue organic dye, and (iv) combinations thereof.

In some embodiments, the at least two organic dyes comprise at least one dye combination selected from the group consisting of a solvent red dye and a solvent green dye, a solvent violet dye and a solvent yellow dye or disperse yellow dye, and a solvent orange dye and a solvent blue dye. The at least two organic dyes can comprise at least two of the dye combinations, or at least three such dye combinations.

In some embodiments, the at least two organic dyes comprise at least one dye combination selected from the group consisting of a solvent, disperse or vat red dye and a solvent or disperse green dye, a solvent or disperse violet dye and a solvent or disperse blue dye, a solvent, disperse or vat red dye and a solvent or disperse blue dye, a solvent or disperse yellow dye and a solvent or disperse blue, a solvent or disperse orange dye and solvent or disperse blue dye. The at least two organic dyes can comprise at least two of the dye combinations, or at least three such dye combinations.

Specific organic dyes and organic pigments suitable for use among the at least two organic dyes include Disperse Yellow 54, Disperse Yellow 201, Solvent Yellow 33, Solvent Yellow 63, Solvent Yellow 93, Solvent Yellow 98, Solvent Yellow 104, Solvent Yellow 114, Solvent yellow 160, Solvent Yellow 188, Pigment Yellow 110, Pigment Yellow 138, Pigment Yellow 147, Pigment Yellow 180, Pigment Yellow 183, Pigment Yellow 184 Solvent Green 3, Solvent Green 28, Pigment Green 7, Pigment Green 36, Solvent Red 52, Solvent Red 135, Solvent Red 149, Solvent Red 179, Solvent Red 207, Vat Red 41, Pigment Red 122, Pigment Red 149, Pigment Red 178, Pigment Red 181, Pigment Red 202, Pigment Red 254, Solvent Violet 13, Solvent Violet 36, Disperse Violet 26, Disperse Violet 31, Pigment Violet 19, Disperse Orange 47, Solvent Orange 60, Solvent Orange 63, Solvent Orange 60, Solvent Orange 63, Solvent Orange 64, Pigment Orange 71 and Solvent Blue 97, Solvent Blue 104, Pigment Blue 15, 15:1, 15:2 15:3 & 15:4, Pigment Blue 60. Other dyes and pigments are possible.

The total concentration of the at least two organic dyes is greater than or equal to 0.001 weight percent, based on the total weight of the thermoplastic composition, more specifically in an amount greater than or equal to 0.02 weight percent, even more specifically in an amount greater or equal than 0.12 weight percent. Those skilled in the art can select relative amounts of particular dyes or pigments. For example, when the at least two organic dyes comprise two dyes from opposite sides of the color wheel, the weight ratio of the two dyes can be about 0.5 to 2, specifically about 0.7 to about 1.5, more specifically about 1:1. Also, when the at least two organic dyes comprise two dyes from opposite sides of the color wheel, the weight ratio of the two dyes can be about 0.1 to 10, specifically about 0.7 to about 1.5, more specifically about 1:1

In some embodiments the at least two organic pigments is selected from the group of (i) mixtures comprising a green organic pigments and a red organic pigment, (ii) mixtures comprising an orange organic pigments, blue organic pigments, and red organic pigments (iii) mixtures comprising a purple organic pigment, a yellow organic pigment and a blue organic pigment, (iv) mixtures comprising blue organic pigments, yellow organic pigments, and red organic pigments and (v) combinations thereof.

In some embodiments the at least two organic pigments is selected from the group of (i) mixtures comprising a green organic pigments and a red organic pigment, (ii) mixtures comprising a blue organic pigment and a red organic pigment, (iii) mixtures comprising an orange organic pigments, blue organic pigments, and red organic pigments (iii) mixtures comprising a yellow organic pigment, a blue organic pigment and a red organic pigment, (iv) mixtures comprising a purple organic pigment and a blue organic pigment, (v) mixtures comprising an orange organic pigment, purple organic pigment and a blue organic pigments, (vi) mixtures comprising a yellow organic pigment, a purple organic pigment and a blue organic pigment and (vii) combinations thereof.

In some embodiments the at least one organic dye and an organic pigment is selected from the group of (i) mixtures comprising a green organic pigments and a red organic dyes, (ii) mixtures comprising a green organic dyes and a red organic pigments, (iii) mixtures comprising an orange dye, a blue organic pigment, and red organic dyes, (iv) mixtures comprising an orange organic dyes, blue organic dyes, and red organic pigments, and (v) mixtures comprising an orange organic pigments, blue organic dyes, and red organic dyes, and (vi) mixtures comprising a purple organic dyes, a yellow organic dyes and a blue organic pigments, and (iv) combinations thereof.

In some embodiments the at least one organic dye and an organic pigment is selected from the group of (i) mixtures comprising a green organic pigments and a red organic dyes, (ii) mixtures comprising a green organic dyes and a red organic pigments, (iii) mixtures comprising a blue organic pigment and a red organic dye, (iv) mixtures comprising a blue organic dye and a red organic pigment, (v) mixtures of a yellow organic pigment, a blue organic dye and a red organic dye, (vi) mixtures a yellow organic pigment, a blue organic pigment and a red organic dye, (vii) mixtures a yellow organic pigment, a blue organic dye and a red organic pigment, (viii) mixtures a yellow organic dye, a blue organic pigment and a red organic pigment, (ix) mixtures a yellow organic dye, a blue organic dye and a red organic pigment, (x) mixtures a yellow organic dye, a blue organic pigment and a red organic dye, (xi) mixtures comprising a purple organic pigment and a blue dye, (xii) mixtures comprising a purple organic dye and a blue organic pigment, (xiii) mixtures comprising an orange organic pigment, a purple organic pigment and a blue organic dye, (xiv) mixtures comprising an orange organic pigment, a purple organic dye and a blue organic pigment, (xv) mixtures comprising an orange organic dye, a purple organic pigment and a blue organic pigment, (xvi) mixtures comprising an orange organic dye, a purple organic dye and a blue organic pigment, (xvii) mixtures comprising an orange organic dye, a purple organic pigment and a blue organic dye, (xviii) mixtures comprising a yellow organic pigment, a blue organic pigment and a red organic dye, (xix) mixtures comprising a yellow pigment, a blue dye and a red pigment, (xx) mixtures comprising a yellow organic dye, a blue organic pigment and a red organic pigment, (xxi) mixtures comprising a yellow dye, a blue organic pigment, and red organic dyes, (xxii) mixtures comprising a yellow organic dye, blue organic dyes, and red organic pigments, and (xxiii) combinations thereof.

Also disclosed herein is an article comprising a concave lens comprising a polymer and a colorant component wherein the lens has a width of 0.1 millimeter to 10 millimeter, a length of 0.1 millimeter to 50 millimeters, and a thickness of 0.2 millimeter to 5 millimeter; wherein the lens transmits light having a wavelength of 850 nanometers to 1550 nanometers and does not transmit light at a wavelength of 380 to 760 nm wherein the colorant component comprises at least two organic dyes such as a green dye and a red dye, an orange dye and blue dye or a purple dye and a yellow dye, and the polymer comprises a polyimide comprising structural units derived from

(A) a dianhydride/diamine pair wherein the pair comprises
(i) oxydiphthalic anhydride and diaminodiphenylsulfone,
(ii) a dianhydride selected from the group consisting of oxydiphthalic anhydride, 3,3, bisphenol A dianhydride, 4,4, bisphenol A dianhydride, and combinations of the foregoing dianhydrides and a diamine selected from the group consisting of meta-phenylenediamine, para-phenylenediamine, diaminodiphenyl sulfone, oxydianiline, and combinations of the foregoing diamines,

(B) a chloro-substituted phthalic anhydride, a diamine selected from the group consisting of meta-phenylenediamine, para-phenylenediamine, diaminodiphenyl sulfone, oxydianiline, dihydroxy phenol salts, and combinations thereof; or

(C) a combination of (A) and (B); and wherein the lens is transparent and dimensionally stable at a wall thickness of at least 0.2 millimeters to 5.0 millimeters and remains transparent and dimensionally stable after being (a) exposed to a precondition of 60° C./60% relative humidity for 120 hours and (b) then subjected to a lead free solder test having a peak temperature of 260° C. for up to 30 seconds.

Also disclosed herein is an article comprising a concave lens comprising a polymer and a colorant component wherein the lens has a width of 0.1 millimeter to 10 millimeter, a length of 0.1 millimeter to 50 millimeters, and a thickness of 0.2 millimeter to 5 millimeter; wherein the lens transmits light having a wavelength of 850 nanometers to 1550 nanometers and transmit light less than 20% at a wavelength of 380 to 700 nm and greater than zero percent at wavelength of 670 to 760 nm wherein the colorant component comprises at least two organic dyes such as a green dye and a red dye, an red dye and blue dye or a purple dye and a blue dye, and the polymer comprises a polyimide comprising structural units derived from

(A) a dianhydride/diamine pair wherein the pair comprises
(i) oxydiphthalic anhydride and diaminodiphenylsulfone,
(ii) a dianhydride selected from the group consisting of oxydiphthalic anhydride, 3,3, bisphenol A dianhydride, 4,4, bisphenol A dianhydride, and combinations of the foregoing dianhydrides and a diamine selected from the group consisting of meta-phenylenediamine, para-phenylenediamine, diaminodiphenyl sulfone, oxydianiline, and combinations of the foregoing diamines,

(B) a chloro-substituted phthalic anhydride, a diamine selected from the group consisting of meta-phenylenediamine, para-phenylenediamine, diaminodiphenyl sulfone, oxydianiline, dihydroxy phenol salts, and combinations thereof; or

(C) a combination of (A) and (B); and wherein the lens is transparent and dimensionally stable at a wall thickness of at least 0.2 millimeters to 5.0 millimeters and remains transparent and dimensionally stable after being (a) exposed to a precondition of 60° C./60% relative humidity for 120 hours and (b) then subjected to a lead free solder test having a peak temperature of 260° C. for up to 30 seconds.

Although our invention includes embodiments that are lenses comprising polyimides, it is understood that our invention can include lenses made from high heat polymers. As such, in one embodiment, our invention includes an article comprising a lens having a width of 0.1 millimeters to 100 millimeters, a length of 0.5 millimeters to 500 millimeters, and a thickness of 0.2 millimeters to 5 millimeters; and the lens (i) transmits more than 60% of light having a wavelength of 760 nanometers to 2500 nanometers, (ii) transmits less than 15% of light having a wavelength of 380 to 700 nm and (iii) transmits more than 15% of light having a wavelength of more than 700 to 760 nm, wherein the lens comprises a polymer and a colorant component, and the polymer comprises:

a high heat polymer having a glass transition temperature that is more than 180 C, the high heat polymer selected from the group consisting of polyimides, polyphenylene sulfones, polyethersulfones, polysulfones, and polyetheretherketone, and combinations thereof;

and wherein the lens is transparent and dimensionally stable at a wall thickness of at least 0.2 millimeters to 5.0 millimeters and remains transparent and dimensionally stable after being (a) exposed to a precondition of 60° C./60% relative humidity for 120 hours and (b) then subjected to a lead free solder test having a peak temperature of 260° C. for up to 30 seconds.

Although our invention includes embodiments that are lenses comprising polyimides, it is understood that our invention can include lenses made from high heat polymers. As such, in one embodiment, our invention includes an article comprising a lens having a width of 0.1 millimeters to 100 millimeters, a length of 0.5 millimeters to 500 millimeters, and a thickness of 0.2 millimeters to 5 millimeters; and the lens (i) transmits more than 60% of light having a wavelength of 760 nanometers to 2500 nanometers, (ii) transmits less than 20% of light having a wavelength of 380 to 700 nm and (iii) transmits more than zero percent of light having a wavelength of more than 670 to 760 nm, wherein the lens comprises a polymer and a colorant component, and the polymer comprises:

a high heat polymer having a glass transition temperature that is more than 180 C, the high heat polymer selected from the group consisting of polyimides, polyphenylene sulfones, polyethersulfones, polysulfones, and polyetheretherketone, and combinations thereof;

and wherein the lens is transparent and dimensionally stable at a wall thickness of at least 0.2 millimeters to 5.0 millimeters and remains transparent and dimensionally stable after being (a) exposed to a precondition of 60° C./60% relative humidity for 120 hours and (b) then subjected to a lead free solder test having a peak temperature of 260° C. for up to 30 seconds.

Lenses of our invention can be made by any suitable method. For instance, in one embodiment, lenses can be made by injection molding techniques, where the appropriate composition is melted and subjected to injection molding conditions that result in a lens that is within the parameters of our invention. In other embodiments, lenses can be made by film pressing techniques. Lenses can be subjected to suitable polishing and finishing techniques that may be appropriate the need at hand. Details of such processes, polishing techniques, and finishing techniques are evident with routine experimentation.

The following examples are included to provide additional guidance to those skilled in the art. The examples provided are merely representative are not intended to limit the invention, as defined in the appended claims, in any manner.

### EXAMPLES

### Examples 1-30

The purpose of Examples 1-30 was to determine the surface mount capability of different polyimide materials, per the Joint Electronic Device Engineering Council (JEDEC) standard test protocol described below.

The materials used in Examples 1-30 are shown below in Table 1.

TABLE 1

| | Monomers | Source, Vendor |
|---|---|---|
| Polyimide 1 | Bisphenol A dianhydride | SABIC |
| | and m-phenylene diamine | INNOVATIVE |
| | | PLASTICS* |
| Polyimide 2 | 3-chlorophthalic anhydride, | SABIC |
| | bisphenol-A and | INNOVATIVE |
| | diaminodiphenyl sulfone | PLASTICS* |
| Polyimide 3 | Oxydiphthalic anhydride | SABIC |
| | and diaminodiphenyl sulfone | INNOVATIVE |
| | | PLASTICS* |
| Polyimide 4 | 4,4-Bisphenol A | SABIC |
| | dianhydride and | INNOVATIVE |
| | diaminodiphenyl sulfone | PLASTICS* |
| Solvent Green 3 | Not applicable | |
| Solvent Red 179 | Not applicable | |
| Carbon black | Not applicable | |

*Commercially sold by SABIC Innovative Plastic under the marks of ULTEM and EXTEM.

### Lens Preparation Methods

Samples in the form of lenses were made by injection molding the respective compositions. The lenses were molded into varying thickness from 0.1 mm-3.2 mm.

### Testing Protocols

The lenses were subjected to lead free solder test temperature profile, according to IPC/JEDEC J-STD-202C entitled “Moisture/Reflow Sensitivity Classification for Non-hermetic Solid State Surface Mount Devices.”

The molded samples in the form of lenses having varying thickness ranging from 0.1 mm to 3.2 mm were conditioned in a humidity chamber at 60° C./60 RH (Relative Humidity) for the specified number of hours shown in the tables. These samples were then mounted on an oven chamber simulating a lead free solder surface mount technology (SMT) process according to the IPC/JEDEC J-STD-202C thermal profile.

The transmission is measured at varying wavelengths using spectrophotometer. Transmission was measured at 850, 1310 and 1550 nm, respectively. A sample was deemed to pass the JEDEC standard protocol when the lens was transparent and dimensionally stable at a wall thickness of at least 0.1 millimeters to 5.0 millimeters and remains transparent and dimensionally stable (no distortion) after being (a) exposed to a precondition of 60° C./60% relative humidity for 120 hours and (b) then subjected to a lead free solder test having a peak temperature of 260° C. for up to 30 seconds.

For Examples 1-12, lenses were made using Polyimide 2 described in Table 1. The lenses were tested for their dimensional stability as described above. Results are also shown in the Tables 2-3.

TABLE 2

| | | Example No | | | | | |
|---|---|---|---|---|---|---|---|
| | | 1 | 2 | 3 | 4 | 5 | 6 |
| | | Sample | | | | | |
| | | Poly- | Poly- | Poly- | Poly- | Poly- | Poly- |
| | | imide | imide | imide | imide | imide | imide |
| | | 2 | 2 | 2 | 2 | 2 | 2 |
| Lead | Thickness | 0.4 | 0.8 | 1.2 | 1.6 | 2 | 3.2 |
| Free | (mm) | | | | | | |
| Solder | Conditions | Dry | Dry | Dry | Dry | Dry | Dry |
| Reflow | (RH/temp)* | | | | | | |
| Test | Peak | 260 | 260 | 260 | 260 | 260 | 260 |
| | temperature | | | | | | |
| | Lead Free | Pass | Pass | Pass | Pass | Pass | Pass |
| | Solder | | | | | | |
| | Reflow | | | | | | |
| | Test Results | | | | | | |
| Trans- | Transmission | >72 | >72 | >72 | 69 | 68 | 50 |
| mission | at 850 nm, % | | | | | | |
| Test | Transmission | >85 | >85 | >85 | 83 | 82 | 77 |
| | at 1310 nm, % | | | | | | |
| | Transmission | >85 | >85 | >85 | 83 | 82 | 77 |
| | at 1550 nm, % | | | | | | |

*Conditioning temperature was 150° C.

TABLE 3

| | | Example No | | | | | |
|---|---|---|---|---|---|---|---|
| | | 7 | 8 | 9 | 10 | 11 | 12 |
| | | Sample | | | | | |
| | | Poly- | Poly- | Poly- | Poly- | Poly- | Poly- |
| | | imide | imide | imide | imide | imide | imide |
| | | 2 | 2 | 2 | 2 | 2 | 2 |
| Lead | Thickness | 0.4 | 0.8 | 1.2 | 0.4 | 0.8 | 1.2 |
| Free | (mm) | | | | | | |
| Solder | Conditions | 60/60 | 60/60 | 60/60 | 85/85 | 85/85 | 85/85 |
| Reflow | (RH/temp) | | | | | | |
| Test | Peak | 260 | 260 | 260 | 260 | 260 | 260 |
| | temperature | | | | | | |
| | Lead Free | Pass | Pass | Pass | Pass | Pass | Pass |
| | Solder | | | | | | |
| | Reflow | | | | | | |
| | Test Results | | | | | | |
| Trans- | Transmission | >72 | >72 | >72 | >72 | >72 | >72 |
| mission | at 850 nm, % | | | | | | |
| Test | Transmission | >85 | >85 | >85 | >85 | >85 | >85 |
| | at 1310 nm, % | | | | | | |
| | Transmission | >85 | >85 | >85 | >85 | >85 | >85 |
| | at 1550 nm, % | | | | | | |

### Discussion of Examples 1-12

Our results showed that the lens passed the JEDEC protocol, namely that the lens was transparent and dimensionally stable at a wall thickness of at least 0.2 millimeters to 5 millimeters and remained transparent and dimensionally stable after being (a) exposed to a precondition of 60° C./60% relative humidity for 120 hours and (b) then subjected to a lead free solder test having a peak temperature of 260° C. for up to 30 seconds.

### Examples 13-18

For Examples 13-18, lenses were made using Polyimide 3 described in Table 1. The lenses were tested for their dimensional stability as described above. Results are shown in the Table 4.

TABLE 4

| | | Example No | | | | | |
|---|---|---|---|---|---|---|---|
| | | 13 | 14 | 15 | 16 | 17 | 18 |
| | | Sample | | | | | |
| | | Poly- | Poly- | Poly- | Poly- | Poly- | Poly- |
| | | imide | imide | imide | imide | imide | imide |
| | | 3 | 3 | 3 | 3 | 3 | 3 |
| Lead | Thickness | 1.6 | 2 | 3.2 | 1.6 | 2 | 3.2 |
| Free | (mm) | | | | | | |
| Solder | Conditions | Dry* | Dry* | Dry* | 60/60 | 60/60 | 60/60 |
| Reflow | (RH/temp) | | | | | | |
| Test | Peak | 260 | 260 | 260 | 260 | 260 | 260 |
| | temperature | | | | | | |
| | Lead Free | Pass | Pass | Pass | Pass | Pass | Pass |
| | Solder | | | | | | |
| | Reflow | | | | | | |
| | Test Results | | | | | | |
| Trans- | Transmission | >70 | 65 | 60 | >70 | 65 | 60 |
| mission | at 850 nm, % | | | | | | |
| Test | Transmission | >82 | 81 | 81 | >82 | 81 | 81 |
| | at 1310 nm, % | | | | | | |
| | Transmission | >82 | 81 | 81 | >82 | 81 | 81 |
| | at 1550 nm, % | | | | | | |

*Conditioning temperature was 150° C.

### Discussion of Examples 13-18

Our results showed that the lens passed the JEDEC protocol—the lens was transparent and dimensionally stable at a wall thickness of at least 0.2 millimeters to 5.0 millimeters and remained transparent and dimensionally stable after being (a) exposed to a precondition of 60° C./60% relative humidity for 120 hours and (b) then subjected to a lead free solder test having a peak temperature of 260° C. for up to 30 seconds.

### Examples 19-24

For Examples 19-24, lenses were made in accordance to the compositions indicated in Table 5. The lenses were tested for their dimensional stability as described above. Results are also shown in Table 5.

TABLE 5

| | | Example No. | | | | | |
|---|---|---|---|---|---|---|---|
| | | 19 | 20 | 21 | 22 | 23 | 24 |
| | | Sample | | | | | |
| | | Poly- | Poly- | Poly- | Poly- | Poly- | Poly- |
| | | imide | imide | imide | imide | imide | imide |
| | | 3/4 | 3/4 | 3/4 | 3/4 | 3/2 | 3/2 |
| | | 60/40 | 60/40 | 60/40 | 60/40 | 60/40 | 60/40 |
| | | wt % | wt % | wt % | wt % | wt % | wt % |
| Lead | Thickness | 1.6 | 3.2 | 1.6 | 3.2 | 1.6 | 3.2 |
| Free | (mn) | | | | | | |
| Solder | Conditions | Dry* | Dry* | 60/60 | 60/60 | 60/60 | 60/60 |
| Reflow | (RH/temp) | | | | | | |
| Test | Peak | 260 | 260 | 260 | 260 | 260 | 260 |
| | Temperature | | | | | | |
| | Lead Free | Pass | Pass | Pass | Pass | Pass | Pass |
| | Solder | | | | | | |
| | Reflow | | | | | | |
| | Test Results | | | | | | |
| Trans- | Transmission | 76 | 66 | 76 | 66 | 66 | 55 |
| mission | at 850 nm, % | | | | | | |
| Test | Transmission | 85 | 84 | 85 | 84 | 82 | 79 |
| | at 1310 nm, % | | | | | | |
| | Transmission | 84 | 82 | 84 | 82 | 82 | 79 |
| | at 1550 nm, % | | | | | | |

*Conditioning temperature was 150° C.

### Discussion of Examples 19-24

Our results showed that the lens passed the JEDEC protocol—lenses were transparent and dimensionally stable at a wall thickness of at least 0.2 millimeters to 5.0 millimeters and remains transparent and dimensionally stable after being (a) exposed to a precondition of 60° C./60% relative humidity for 120 hours and (b) then subjected to a lead free solder test having a peak temperature of 260° C. for up to 30 seconds.

### Examples 25-28

For Examples 25-28, lenses were made Polyimide 1 described in Table 1. The lenses were tested for their dimensional stability as described above. Results are shown in Table 8.

TABLE 8

| | | Example No | | | |
|---|---|---|---|---|---|
| | | 25 | 26 | 27 | 28 |
| | | Sample | | | |
| | | Poly- | Poly- | Poly- | Poly- |
| | | imide 1 | imide 1 | imide 1 | imide 1 |
| Lead | Thickness | 1.6 | 3.2 | 1.6 | 3.2 |
| Free | (mm) | | | | |
| Solder | conditions | Dry* | Dry* | 60/60 | 60/60 |
| Reflow | (RH/temp) | | | | |
| Test | Peak | 260 | 260 | 260 | 260 |
| | temperature | | | | |
| | Lead Free | FAIL | FAIL | FAIL | FAIL |
| | Solder | | | | |
| | Reflow | | | | |
| | Test Results | | | | |
| Trans- | Transmission | 86 | 67 | 86 | 67 |
| mission | at 850 nm, % | | | | |
| Test | Transmission | 88 | 87 | 88 | 87 |
| | at 1310 nm, % | | | | |
| | Transmission | 87 | 85 | 87 | 85 |
| | at 1550 nm, % | | | | |

*Conditioning temperature was 150° C.

### Discussion of Examples 25-28

Inexplicably, the compositions containing Polyimide 1 did not result in compositions having useful properties. More particularly, results showed that lenses made from Polyimide 1 were not both transparent and dimensionally stable at a wall thickness of at least 0.2 millimeters to 5.0 millimeters and remain transparent and dimensionally stable after being (a) exposed to a precondition of 60° C./60% relative humidity for 120 hours and (b) then subjected to a lead free solder test having a peak temperature of 260° C. for up to 30 seconds.

### Examples 29-34

Examples having the compositions shown in Table 9 were made and tested as described below.

TABLE 9

| | 29 | 30 | 31* | 32 | 33* | 34 |
|---|---|---|---|---|---|---|
| Polyimide 3 | 100 | 99.88 | 99.7 | — | — | — |
| Polyimide 1 | — | — | | 100 | 100 | 99.6 |
| Carbon Black | — | — | 0.3 | | 0.4 | |
| C.I. Solvent | — | 0.06 | — | — | — | 0.2 |
| Green 3 | | | | | | |
| C.I. Solvent Red | — | 0.06 | — | — | — | 0.2 |
| 179 | | | | | | |

Examples 29 and 32 are natural polyimide with no pigment added. Examples 30 and 34 contain polyimides with two organic dyes, as shown in Table 9. These examples are intended to compare and contrast the optical properties of natural uncolored polymer and organic dye added polymer. Comparative examples 31 and 33 contain carbon black pigment.

Extrusion and Molding:

Components of each sample according to formulae above were dry-blended for 3-5 minutes to ensure even distribution of dyes into the resin. Examples 29-31 were then fed at the feed-throat of a WP30 co-rotating twin screw extruder. Examples 32-34 were fed at the feed-throat of Prizm extruder (25 mm twin extruder model TSE24 HC) to extrude according the process condition below.

The screws were run at 200 rpm with a vacuum condition of 28 inches Hg and 20-25 pounds per hour (lb/hr) (9.1-11.3 kilograms per hour) of throughput. The strands were cooled through a water bath and then pelletized.

Extrusion conditions (° C. in brackets) for Examples 29-31:

TABLE 10

| Die | Z-7 | Z-6 | Z-5 | Z-4 | Z-3 | Z-2 | Z-1 |
|---|---|---|---|---|---|---|---|
| 388 | 382 | 377 | 371 | 371 | 365 | 204 | 204 |

Extrusion conditions for Examples 32-34:

TABLE 11

| Die | Z-7 | Z-6 | Z-5 | Z-4 | Z-3 | Z-2 | Z-1 |
|---|---|---|---|---|---|---|---|
| 343 | 338 | 338 | 327 | 288 | 260 | 204 | 71 |

Molding Conditions:

Extruded pellets from Examples 29-31 were dried at 149 degrees C. for 4-6 hours and then molded into 2 in×3 in color step chips of 1, 1.6, 2, and 3.2 mm thickness using a 180T DEMAG molding machine using the conditions shown in Table 12. Examples 32-34 were dried at 121 degrees C. for 2 hours and then molded into 2 in×3 in color step chips having a thickness of 2.5 mm in 85T molder (model FN 1000 by Nissei Plastic Industry) according to the process condition defined Table 13.

TABLE 12

| Nozzle | Front | Middle | Rear | Mold |
|---|---|---|---|---|
| 388 | 388 | 388 | 388 | 163 |

TABLE 13

| Nozzle | Front | Middle | Rear | Mold |
|---|---|---|---|---|
| 354 | 360 | 354 | 338 | 135 |

Examples 29 and 30 were subjected to extended (abusive) molding conditions. Both Examples 29 and 30 were subjected to a molding temperature of 399 degrees C. and 3 residence times of 2.5 minutes, 5 minutes and 7.5 minutes. At each of the three residence time conditions, color chips were molded and the Transmission was measured. The residence times were calculated from the equation below. The data were incorporated into the Equation 1 below and a cycle time of ˜30, 60 and 90 was set to get a residence time to 2.5, 5 and 7.5 minutes of the polymer melt in the barrel. Color chips were molded at three residence times of 2.5 min, 5 min and 7.5 min at the temperature setting mentioned above. Between residence time changes, the first 5 parts were always discarded to ensure that each shot remained in the barrel for the entire residence time.

### Residence Time Calculation

$$t = \frac{\begin{matrix}( Barrel size ( oz ) ) ( Sp . Gr . / 1.05 ) \\ ( 28.35 g \text{/} oz ) ( Cycle time ( secs ) )\end{matrix}}{Part Weight ( g )}$$

For Examples 29-31, measurements were made using a 2000 thermo-coupler metricon refracto-meter and transmission spectra were measured using Hitachi spectrophotometer over a range of 300 nm to 1600 nm. The change in refractive index with temperature (dn/dT) was measured using refractometer with thermal capability, temperature varying from 23 C to 120 C.

The lead free solder reflow test was carried out using a reflow simulator SRS-1C (Malcom) instrument. The test coupons were injection molded circular discs. The tests were carried out as per JEDEC rating with 60% Relative Humidity/60 C and 80% Relative Humidity/80 C conditioning before testing. The peak temperature of reflow test was 260 C for 10 sec.

For Examples 32-34, measurements were made using spectrophotometer Color Eye 7000 by Gretag Macbeth, set at D65 illuminant, 10-degree observer Specular Component Included (SCI) mode for color data and spectra graphs at wavelength in visible range between 400 nm through 700 nm, Perkin Elmer UV-Vis-NIR spectrometer for both reflectance and transmission at wavelength between 450 nm to 1100 nm.

Molded color chips of Examples 29 and 30 at different thickness are shown below in Table 14. The % Transmission at 850 nm, 1310 nm and 1550 nm are compared for both samples and the unique feature is, the samples have similar transmission data in the near-IR range. Given a visually black looking color chip, Example 30 shows high transmission in the near-IR range which is similar in magnitude to the natural colored Example 29.

TABLE 14

| | Wavelength | Transmittance (%) at indicated thickness | | | |
|---|---|---|---|---|---|
| | (nm) | 1 mm | 1.6 mm | 2 mm | 3.2 mm |
| Example 29 | 1550 | 87.3 | 85.8 | 85.1 | 82.8 |
| | 1310 | 88.0 | 87.1 | 86.5 | 84.8 |
| | 850 | 84.2 | 81.7 | 79.5 | 76.1 |
| Example 30 | 1550 | 87.2 | 85.6 | 84.8 | 82.3 |
| | 1310 | 87.8 | 86.7 | 85.9 | 84.1 |
| | 850 | 83.9 | 80.9 | 78.9 | 74.6 |

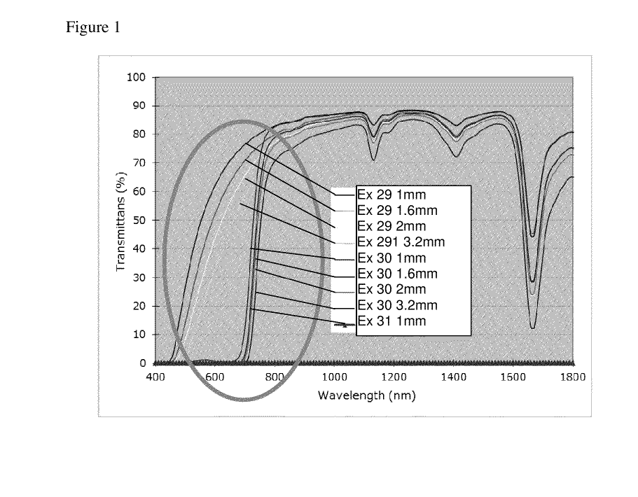

However, in the visible region (400-700 nm) region, Example 30 shows desired black color and exhibits very low transmission if not near zero transmission in this range whereas Example 29, the natural resin, shows amber color and high transmission in this range for a given thickness. Again, this is the unique feature of Example 30 with organic dyes, which made black color, blocked visible light and transmitted IR light at the same level as the natural resin did. Example 31 as expected shows zero transmission across the visible as well as near-IR wavelength region as the result of containing carbon black pigment. Importantly, both Examples 30 and 31 were perceived black visually, however it is unique property of Example 30 that it shows high transmittance in the near-IR range of 760-1800 nm similar to Example 29 and simultaneously blocks visible light interference (400-700 nm) similar to Example 31. This data is shown in FIG. 1.

Shown below in Table 15 are refractive index properties of Example 29 and Example 30 for different wavelengths ranging from visible (400-700 nm) and near IR (850-1550 nm) wavelengths. One can see that the Example 30 has similar refractive index to Example 29 which is again a unique feature, given that Example 30 contains the polymer+organic dye. In summary, the organic dye in Example 30 does not alter the refractive index properties of the natural polymer (Example 29).

TABLE 15

| | | Wavelength | | |
|---|---|---|---|---|
| | | (nm) | Examples 29 | Example 30 |
| Refractive | | 1550 | 1.6207 | 1.6204 |
| Index | | 1310 | 1.6239 | 1.6237 |
| | | 850 | 1.6355 | 1.6357 |
| | nC | 656.3 | 1.6503 | 1.6506 |
| | nd | 587.6 | 1.6599 | 1.6601 |
| | ne | 546.1 | 1.6678 | 1.6677 |
| | nF | 486.1 | 1.6837 | 1.6828 |
| | ng | 435.8 | 1.7035 | 1.7012 |
| | | Abbe | 19.8 | 20.5 |

Shown below is the abusive molding study conducted on Examples 29 and 30. The effort of this study was to a) compare and contrast the optical properties of Examples 29 and 30 and b) check the stability of the organic dye in Example 30 against high temperatures and long residence times.

Both Examples 29 and 30 were subjected to a molding temperature of 750 degrees F. and 3 residence times of 2.5 minutes, 5 minutes and 7.5 minutes. At each of the three residence time conditions, color chips were molded and the light transmission was measured.

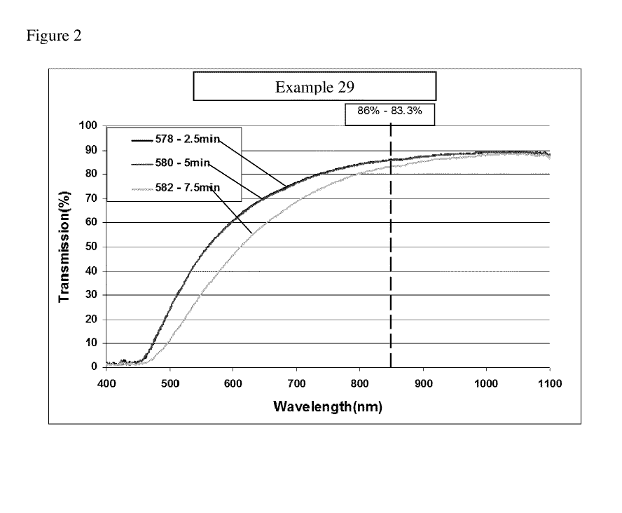

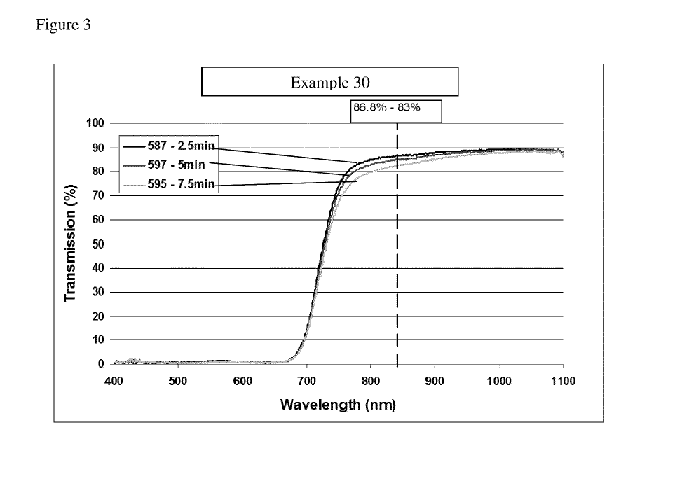

Graph of Transmission (%) Vs. Wavelength (nm) are plotted below in two graphs (FIGS. 2 and 3). In the case of Example 29, the change in % Transmission after 7.5 minutes residence time was found to be approximately 3%.

In case of Example 30, the change in % Transmission after 7.5 minutes residence time was found to be approximately 4%. Thus it can be concluded that the major component of the delta change in optical transmission for Example 30 is coming from the polymer degradation and not necessarily from dye degradation. This is again a unique result in that the organic dye may remain thermally stable at up to 750 degrees F. and up to 7.5 minutes of residence time while still providing high % Transmission at the wavelength regions of interest.

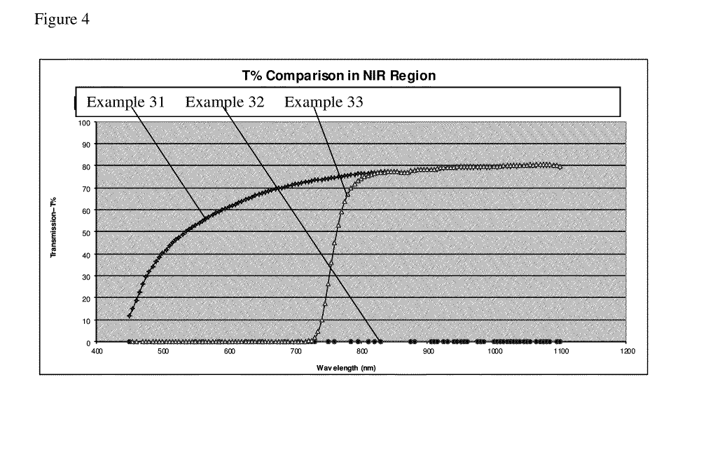

Example 32 which is natural resin (no pigment or dye added) has a transmission curve from 400-1100 nm wavelength as shown in FIG. 4. The transmission graph below shows that the black Example 33 (a comparative example) made of conventional carbon black pigment has zero transmission across the board of wavelengths in visible region from 450 nm through 700 nm, suggesting that the sample is perceived as black color, and then extend to near IR region up to 1100 nm, suggesting that the sample absorbs all IR radiation, implying all light radiation is absorbed by Example 33.

Contrarily, inventive Example 34 shows also zero transmission in visible region as does Example 32, suggesting that the sample is also perceived as black color, however shows high transmission over the entire near IR region from 800 nm to 1100 nm, a unique feature distinguishing the Example 34 from Example 33. In addition, the Example 34, achieves the similar level of transmission in near IR region as high as the natural resin permits (Example 32), suggesting that the maximum IR transmittance of the invention is a function of the thermoplastic resin chosen.

While the invention has been described with reference to a several embodiments, it will be understood by those skilled in the art that various changes may be made and equivalents may be substituted for elements thereof without departing from the scope of the invention. In addition, many modifications may be made to adapt a particular situation or material to the teachings of the invention without departing from essential scope thereof. Therefore, it is intended that the invention not be limited to the particular embodiments disclosed as the best mode contemplated for carrying out this invention, but that the invention will include all embodiments falling within the scope of the appended claims.

What is claimed:

1. An article comprising a lens having a width of 0.1 millimeters to 100 millimeters, a length of 0.5 millimeters to 500 millimeters, and a thickness of 0.2 millimeters to 5 millimeters; and the lens transmits more than 60% of light having a wavelength ranging from 760 nanometers to 2500 nanometers, wherein the lens comprises a polymer and a colorant component, and the polymer comprises:
a high heat polymer having a glass transition temperature that is more than 180° C., the high heat polymer selected from the group consisting of polyimides, polyphenylene sulfones, polyethersulfones, polysulfones, and polyetheretherketones, and combinations thereof;
and the colorant component comprises (a) at least two organic dyes, (b) at least an organic dye and an organic pigment, (c) at least two organic pigments, or (d) combinations thereof
and wherein the lens is transparent and dimensionally stable at a wall thickness of at least 0.2 millimeters to 5.0 millimeters and remains transparent and dimensionally stable after being (a) exposed to a precondition of 60° C./60% relative humidity for 120 hours and (b) then subjected to a lead free solder test having a peak temperature of 260° C. for up to 30 seconds.

2. The article of claim 1, wherein the lens transmits less than 20% of light having a wavelength selected from the group consisting of 380 to 670 nm, 380 to 671 nm, 380 to 672 nm, 380 to 673 nm, 380 to 674 nm, 380 to 675 nm, 380 to 676 nm, 380 to 677 nm, 380 to 678 nm, 380 to 679 nm, 380 to 680 nm, 380 to 681 nm, 380 to 682 nm, 380 to 683 nm, 684 nm, 380 to 685 nm, 380 to 686 nm, 380 to 687 nm, 380 to 688 nm, 380 to 689 nm, 380 to 690 nm, 380 to 691 nm, 380 to 692 nm, 380 to 693 nm, 380 to 694 nm, 380 to 695 nm, 380 to 696 nm, 380 to 697 nm, 380 to 698 nm, 380 to 700 nm, and combinations thereof.

3. The article of claim 1, wherein the lens transmits more than 5% of light having a wavelength selected from the group consisting of from more than 670 to 760 nm, 671 to 760 nm, 672 to 760 nm, 673 to 760 nm, 673 to 760 nm, 673 to 760 nm, 674 to 760 nm, 675 to 760 nm, 676 to 760 nm, 677 to 760 nm, 678 to 760 nm, 679 to 760 nm, 680 to 760 nm, 681 to 760 nm, 682 to 760 nm, 683 to 760 nm, 684 to 760 nm, 685 to 760 nm, 686 to 760 nm, 687 to 760 nm, 688 to 760 nm, 689 to 760 nm, 690 to 760 nm, 691 to 760 nm, 692 to 760 nm, 693 to 760 nm, 694 to 760 nm, 695 to 760 nm, 696 to 760 nm, 697 to 760 nm, 698 to 760 nm, 699 to 760 nm, 700 to 760 nm, and combinations thereof.

4. The article of claim 1, wherein the lens selectively transmits light from a member selected from the group consisting of: (1) less than 20% of light having a wavelength of 380 to 670 nm and more than 5% of light having a wavelength of from more than 670 to 760 nm, (2) less than 20% of light having a wavelength of 380 to 671 nm, and more than 5% of light having a wavelength of from more than 671 to 760 nm, (3) less than 20% of light having a wavelength of 380 to 672 nm and more than 5% of light having a wavelength of from more than 672 to 760 nm, (4) less than 20% of light having a wavelength of 380 to 673 nm, and more than 5% of light having a wavelength of from more than 673 to 760 nm, (5) less than 20% of light having a wavelength of 380 to 674 nm, and more than 5% of light having a wavelength of from more than 674 to 760 nm (6) less than 20% of light having a wavelength of 380 to 675 nm, and more than 5% of light having a wavelength of from more than 675 to 760 nm, (7) less than 20% of light having a wavelength of 380 to 676 nm, and more than 5% of light having a wavelength of from more than 676 to 760 nm, (8), less than 20% of light having a wavelength of 380 to 677 nm, and more than 5% of light having a wavelength of from more than 677 to 760 nm, (9) less than 20% of light having a wavelength of 380 to 678 nm, and more than 5% of light having a wavelength of from more than 678 to 760 nm, (10) less than 20% of light having a wavelength of 380 to 679 nm, and more than 5% of light having a wavelength of from more than 679 to 760 nm, (11) less than 20% of light having a wavelength of 380 to 680 nm, and more than 5% of light having a wavelength of from more than 680 to 760 nm, (12) less than 20% of light having a wavelength of 380 to 681 nm, and more than 5% of light having a wavelength of from more than 681 to 760 nm, (13) less than 20% of light having a wavelength of 380 to 682 nm, and more than 5% of light having a wavelength of from more than 682 to 760 nm, (14) less than 20% of light having a wavelength of 380 to 683 nm, and more than 5% of light having a wavelength of from more than 683 to 760 nm, (15) less than 20% of light having a wavelength of 684 nm and more than 5% of light having a wavelength of from more than 684 to 760 nm, (16) less than 20% of light having a wavelength of 380 to 685 nm, and more than 5% of light having a wavelength of from more than 685 to 760 nm, (17) less than 20% of light having a wavelength of 380 to 686 nm, and more than 5% of light having a wavelength of from more than 686 to 760 nm, (18) less than 20% of light having a wavelength of 380 to 687 nm, and more than 5% of light having a wavelength of from more than 687 to 760 nm, (19) less than 20% of light having a wavelength of 380 to 688 nm, and more than 5% of light having a wavelength of from more than 688 to 760 nm, (20) less than 20% of light having a wavelength of 380 to 689 nm, and more than 5% of light having a wavelength of from more than 689 to 760 nm, (21) less than 20% of light having a wavelength of 380 to 690 nm, and more than 5% of light having a wavelength of from more than 690 to 760 nm, (22) less than 20% of light having a wavelength of 380 to 691 nm, and more than 5% of light having a wavelength of from more than 691 to 760 nm, (23) less than 20% of light having a wavelength of 380 to 692 nm, and more than 5% of light having a wavelength of from 692 to 760 nm, (24) less than 20% of light having a wavelength of 380 to 693 nm, and more than 5% of light having a wavelength of from 693 to 760 nm, (25) less than 20% of light having a wavelength of 380 to 694 nm, and more than 5% of light having a wavelength of from 694 to 760 nm, (26) less than 20% of light having a wavelength of 380 to 695 nm, and more than 5% of light having a wavelength of from 695 to 760 nm, (27) less than 20% of light having a wavelength of 380 to 696 nm, and more than 5% of light having a wavelength of from 696 to 760 nm, (28) less than 20% of light having a wavelength of 380 to 697 nm, and more than 5% of light having a wavelength of from 697 to 760 nm, (29) less than 20% of light having a wavelength of 380 to 698 nm, and more than 5% of light having a wavelength of from 698 to 760 nm, (30) less than 20% of light having a wavelength of 380 to 699 nm, and more than 5% of light having a wavelength of from 699 to 760 nm, (31) less than 20% of light having a wavelength of 380 to 700 nm, and more than 5% of light having a wavelength of from 700 to 760 nm, and combinations thereof.

5. An article comprising a lens having a width of 0.1 millimeters to 100 millimeters, a length of 0.5 millimeters to 500 millimeters, and a thickness of 0.2 millimeters to 5 millimeters; and the lens (i) transmits more than 60% of light having a wavelength of 760 nanometers to 2500 nanometers, wherein the lens comprises a polymer and a colorant component, and the polymer comprises:
a polyimide comprising structural units derived from
(A) a dianhydride/diamine pair wherein the pair comprises
(i) oxydiphthalic anhydride and diaminodiphenylsulfone, or
(ii) a dianhydride selected from the group consisting of oxydiphthalic anhydride, 3,3, bisphenol A dianhydride, 4,4, bisphenol A dianhydride, and combinations of the foregoing dianhydrides and a diamine selected from the group consisting of meta-phenylenediamine, para-phenylenediamine, diaminodiphenyl sulfone, oxydianiline, and combinations of the foregoing diamines,
(B) a chloro-substituted phthalic anhydride, a diamine selected from the group of meta-phenylenediamine, para-phenylenediamine, diaminodiphenyl sulfone, oxydianiline and combinations thereof, and a dihydroxy phenol salt, or
(C) a combination selected from the group of (A) and (B);
and the colorant component comprises (a) at least two organic dyes, (b) at least an organic dye and an organic pigment, (c) at least two organic pigments,
or (d) combinations thereof and wherein the lens is transparent and dimensionally stable at a wall thickness of at least 0.2 millimeters to 5.0 millimeters and remains transparent and dimensionally stable after being (a) exposed to a precondition of 60° C./60% relative humidity for 120 hours and (b) then subjected to a lead free solder test having a peak temperature of 260° C. for up to 30 seconds.

6. The article of claim 5, wherein the article transmits less than 15% of light having a wavelength of 380 to 700 nm and transmits more than 15% of light having a wavelength of greater than 700 to 760 nm.

7. The article of claim 5, wherein the at least two organic dyes is selected from the group consisting of (i) a mixture comprising a green organic dye and a red organic dye, (ii) a mixture comprising an orange organic dye, blue organic dye, and red organic dye (iii) a mixture comprising a purple organic dye, a yellow organic dye and a blue organic dye, and (iv) combinations thereof.

8. The article of claim 5, wherein the at least one organic dye and an organic pigment is selected from the group consisting of (i) mixtures comprising a green organic pigments and a red organic dyes, (ii) mixtures comprising a green organic dyes and a red organic pigments, (iii) mixtures comprising an orange dyes, blue organic pigments, and red organic dyes, (iv) mixtures comprising an orange organic dyes, blue organic dyes, and red organic pigments, and (v) mixtures comprising an orange organic pigments, blue organic dyes, and red organic dyes, and, and (vi) mixtures comprising a purple organic dyes, a yellow organic dyes and a blue organic pigments, and (iv) combinations thereof.

9. The article of claim 5, wherein the at least two organic pigments is selected from the group consisting of (i) mixtures comprising a green organic pigments and a red organic pigment, (ii) mixtures comprising an orange organic pigments, blue organic pigments, and red organic pigments (iii) mixtures comprising a purple organic pigment, a yellow organic pigments and a blue organic pigments, (iv) mixtures comprising blue organic pigments, yellow organic pigments, and red organic pigments and (v) combinations thereof.

10. The article of claim 5, wherein the polyimide comprises structural units derived from oxydiphthalic anhydride and diaminodiphenyl sulfone,

11. The article of claim 5, wherein the polyimide comprises structural units derived from 3,3, bisphenol A dianhydride and diaminodiphenyl sulfone,

12. The article of claim 5, wherein the polyimide comprises structural units derived from oxydiphthalic anhydride and 4,4′-oxydianiline,

13. The article of claim 5, wherein the polyimide is a first polyimide polymer and the lens further comprises a second polyimide polymer, thereby forming a polymer blend, and the polymer blend is a non-delaminated polymer miscible polymer blend.

14. The article of claim 13, wherein the first polyimide polymer comprises structural units derived from oxydiphthalic anhydride and diaminodiphenyl sulfone; and the second polyimide polymer comprises structural units derived from a dianhydride/diamine pair selected from the group consisting of (i) 3,3 bisphenol dianhydride and diaminodiphenyl sulfone, (ii) 4,4, bisphenol A dianhydride and metaphenylene diamine, (iii) 4,4, bisphenol A dianhydride and para-phenylenediamine, (iv) 4,4 bisphenol dianhydride and diaminodiphenyl sulfone, and (v) combinations of the foregoing dianhydride/diamine pairs.

15. The article of claim 13, wherein the first polyimide polymer comprises structural units derived from 3,3 bisphenol dianhydride and diaminodiphenyl sulfone; and the second polyimide polymer comprises structural units derived from a dianhydride/diamine pair selected from the group consisting of (i) 4,4, bisphenol A dianhydride and metaphenylene diamine, (ii) 4,4, bisphenol A dianhydride and para-phenylenediamine, (iii) 4,4 bisphenol dianhydride and diaminodiphenyl sulfone, and (iv) combinations of the forgoing dianhydride/diamine pairs.

16. The article of claim 13, wherein
the first polyimide is present in an amount of 50 to 99 weight percent;
the second polyimide is present in an amount of 1 to 50 weight percent; and
the thermoplastic composition further comprises 0 to 70 weight percent of a component selected from the group consisting of fillers, reinforcements, additives, and combinations thereof;
wherein the first polyimide, the second polyimide, and the component are present at a total weight percent of 100.

17. The article of claim 5, wherein the composition further comprises at least one polymer that is not a polyimide.

18. The article of claim 17, wherein the at least one polymer is selected from the group consisting of polyesters, polyestercarbonates, polysulfones, polyether sulfones, polybenzimidizole, polyketones, and combinations of the foregoing polymers.

19. The article of claim 5, wherein the lens has a transparency that is greater than or equal to 60% at a thickness of 2 millimeters.

20. The article of claim 5, wherein the lens transmits light having a wavelength of 1310 nanometers.

21. The article of claim 5, wherein the lens transmits light having a wavelength of 1550 nanometers.

22. The article of claim 5, wherein the lens transmits light having a wavelength of 850 nanometers.

23. The article of claim 5, wherein the polymer has a coefficient of thermal expansion of less than or equal to 100 ppm/° C. from 30° C. to 200° C. as measured by thermal mechanical analysis with a thermal ramp rate of 5° C./minute.

24. The article of claim 5, wherein the polymer blend has a continuous use temperature greater than or equal to 150° C.

25. The article of claim 5, wherein the lens is also transparent and dimensionally stable at a wall thickness of 0.2 millimeters to 5.0 millimeters after being (a) exposed to a precondition of 85° C./85% relative humidity for 120 hours and (b) subjected to a lead free solder test for 30 seconds at 260° C.

26. The article of claim 5, wherein the article is a component of an optical transreceiver.

27. The article of claim 13, wherein the article is a component of an optical transreceiver.

28. The article of claim 5, wherein the lens further comprises less than 20 weight % of a polyketone, based on the total weight of the composition.

29. An article comprising a concave lens wherein the lens has a width of 0.1 millimeter to 100 millimeter, a length of 0.5 millimeter to 500 millimeters, and a thickness of 0.2 millimeter to 5 millimeter;
wherein and the lens transmits more than 60% of light having a wavelength ranging from 760 nanometers to 2500 nanometers,
wherein the lens comprises a polymer and a colorant component and the polymer comprises a polyimide comprising structural units derived from
(A) a dianhydride/diamine pair wherein the pair comprises
(i) oxydiphthalic anhydride and diaminodiphenylsulfone, or
(ii) a dianhydride selected from the group consisting of oxydiphthalic anhydride, 3,3, bisphenol A dianhydride, 4,4, bisphenol A dianhydride, and combinations of the foregoing dianhydrides and a diamine selected from the group consisting of meta-phenylenediamine, para-phenylenediamine, diaminodiphenyl sulfone, oxydianiline, and combinations of the foregoing diamines,
(B) a chloro-substituted phthalic anhydride, a diamine selected from the group consisting of meta-phenylenediamine, para-phenylenediamine, diaminodiphenyl sulfone, oxydianiline and combinations thereof, and a dihydroxy phenol salts, or
(C) a combination selected from the group of (A) and (B);
the colorant comprises at least two organic dyes and wherein the lens is transparent and dimensionally stable at a wall thickness of at least 0.2 millimeters to 5.0 millimeters and remains transparent and dimensionally stable after being (a) exposed to a precondition of 60° C./60% relative humidity for 120 hours and (b) then subjected to a lead free solder test having a peak temperature of 260° C. for up to 30 seconds.

30. The article of claim 29, wherein the article is a component of an optical transceiver.
